(19) United States
(12) Patent Application Publication
(10) Pub. No.: US 2021/0240874 A1
(43) Pub. Date: Aug. 5, 2021

(54) METHOD FOR OPTIMIZING STRUCTURED MESH GENERATION FOR A THERMAL ANALYSIS MODEL OF A ROTOR BAR OF AN AC MOTOR

(71) Applicant: HUNAN UNIVERSITY OF SCIENCE AND TECHNOLOGY, Xiangtan (CN)

(72) Inventors: Xiaoping ZHANG, Xiangtan (CN); Yuxuan GUO, Xiangtan (CN); Zhu ZHANG, Xiangtan (CN); Guanghui ZHU, Xiangtan (CN); Haipeng JIANG, Xiangtan (CN); Hongwei CHEN, Xiangtan (CN)

(21) Appl. No.: 17/235,866

(22) Filed: Apr. 20, 2021

(51) Int. Cl. G06F 30/10

(52) U.S. Cl. CPC G06F 30/10; H02K 17/165

(57) ABSTRACT

Provided is a method for optimizing structured mesh generation for a thermal analysis model of a rotor bar of an AC motor. A quadrilateral is randomly added within the top surface of the thermal analysis model of the rotor bar. The polygonal top surface is divided into multiple quadrilateral areas by drawing lines from each vertex of the quadrilateral to each vertex of the top surface or two points selected randomly on each edge of the top surface, respectively. A fruit fly optimization algorithm is adopted to obtain a maximum value of the average quality of the quadrilateral areas in a division mode and corresponding coordinates of the vertices of the quadrilateral areas. The top surface is divided into multiple quadrilateral areas according to the division mode corresponding to the maximum average quality to divide the model of the rotor bar into multiple columnar models.

### TECHNICAL FIELD

The present application relates to thermal analysis for alternating current (AC) motors, in particular to a method for optimizing structured mesh generation for a thermal analysis model of a rotor bar of an AC motor.

### BACKGROUND

AC motors are widely used due to their simple structure, low cost, and easy maintenance. However, the increase of power density of the AC motor brings the increase of unit volume loss generated during operation, which further causes the continuous increase of temperature rise of the motor. If the motor has high temperature rise, faults, such as the break of rotor bars of the motor and the insulation failure of windings, will be caused. Therefore, it is of great significance to carry out thermal analysis on the AC motor to reduce its temperature rise.

The existing thermal analysis for AC motors mainly includes the simplified formula method, the equivalent thermal circuit method, the finite formulation method and the finite element method. The finite element method has the advantages of good boundary adaptability, uniform algorithm and high accuracy, and has been widely used. However, when the finite element method is adopted to perform thermal analysis on AC motors, mesh generation should be carried out for the finite element model. At present, common mesh generation methods mainly include the triangular mesh generation method and the quadrilateral mesh generation method, in which the quadrilateral mesh generation method has been widely used due to its high calculation accuracy and fast calculation speed. The quadrilateral mesh generation method is further divided into structured mesh generation method and unstructured mesh generation method. The structured mesh generation method has fast mesh generation speed and good mesh quality, which is greatly favored by users.

During operation, the rotor bar of the AC motor is the part with the highest temperature rise of the entire motor, so it is particularly important to improve the accuracy of analysis results of the temperature field thereof. However, since the top surface of the rotor bar is generally polygonal, it should be divided into several quadrilateral areas when using the quadrilateral structured meshing method. At present, the empirical method is generally used to generate quadrilateral areas for polygonal top surfaces, which has higher requirements for operators. In addition, this will cause low mesh generation efficiency and a poor mesh quality.

### SUMMARY

In order to solve the above-mentioned problems, the present disclosure provides a method for optimizing structured mesh generation for a thermal analysis model of a rotor bar of an AC motor.

Provided is a method for optimizing structured mesh generation for a thermal analysis model of a rotor bar of an AC motor, comprising:

1) selecting a polygonal top surface of a model of the rotor bar as a meshing area; establishing a rectangular coordinate system with any vertex of the top surface as an origin of the rectangular coordinate system to obtain rectangular coordinates of vertices of the top surface;

2) sequentially numbering the vertices of the top surface and two points randomly selected on each edge of the top surface with the origin of the rectangular coordinate system of the top surface as a start point;

3) adding a quadrilateral randomly within the top surface of the model; dividing the top surface into a plurality of quadrilateral areas by drawing a line from each vertex of the quadrilateral to each vertex of the top surface or two points selected randomly on each edge of the top surface, respectively, obtaining all division modes that divide the top surface into a plurality of quadrilateral areas;

4) optimizing each of the division modes with coordinates of the vertices of each quadrilateral area except for the vertices of the top surface as an optimization object and an average quality of the quadrilateral areas as an optimization target using a fruit fly optimization algorithm, to obtain a maximum value of the average quality of each quadrilateral area in each division mode and corresponding coordinates of the vertices of the quadrilateral areas;

5) comparing maximum values of the average quality of the quadrilateral areas under the division modes to obtain a division mode corresponding to a maximum average quality of the quadrilateral areas and coordinates of vertices of the quadrilateral areas corresponding to the maximum average quality, wherein the division mode corresponding to the maximum average quality of the quadrilateral areas is taken as an optimal division mode; and 6) dividing the model of the rotor bar into a plurality of columnar models having a quadrilateral top surface according to the optimal division mode obtained in step (5); and subjecting the columnar models to structured meshing through a sweep method to obtain an optimal structured meshing result for the model of the rotor bar.

In some embodiments, the step of sequentially numbering the vertices of the top surface and the two points randomly selected on each edge of the top surface in step (2) comprises:

2-1) taking the vertices of the top surface as corner points, and taking the two points randomly selected on each edge of the top surface as edge points;

2-2) numbering the corner points and the edge points separately;

2-3) taking a corner point where the origin of the rectangular coordinate system is located as No. 1 corner point, sequentially numbering the corner points in a clockwise or counterclockwise direction; and

2-4) numbering the edge points in a direction along which the corner points are numbered, taking a first edge point encountered by the No. 1 corner point in the numbering direction of the corner points as No. 1 edge point, and sequentially numbering the edge points.

In some embodiments, in step (3), the vertices of the quadrilateral added in the top surface of the model are numbered by steps of:

3-1-1) taking the vertices of the quadrilateral as interior points; and

3-1-2) randomly selecting an interior point as No. 1 interior point, and sequentially numbering the interior points in the direction along which the corner points are numbered.

In some embodiments, the step of dividing the top surface into a plurality of quadrilateral areas in step (3) comprises:

3-2-1) taking a connection line between each interior point and each corner point as a first-type connection line; taking a connection line between each interior point and each odd-numbered edge point as a second-type connection line; taking a connection line between each interior point and an even-numbered edge point as a third-type connection line; wherein the interior points in the first-type, second-type and third-type connection lines are taken as first end points, and the corner point, the odd-numbered edge point and the even-numbered edge point respectively in the first-type, second-type and third-type connection lines are taken as second end points;

3-2-2) setting the number of corner points of the top surface as n, the number of edge points of the top surface as m, and m=2n;

3-2-3) determining an initial line for division, wherein the initial line for division is a connection line between No. 1 interior point and No. 1 corner point or a connection line between the No. 1 interior point and No. 1 edge point;

3-2-4) according to a type of the initial connection line, the division mode of the quadrilateral areas and a rule in which the end points are numbered, determining a second line for division as follows:

if the initial line for division is the connection line between the No. 1 interior point and the No. 1 corner point, the second line for division is a connection line between the No. 1 interior point and No. 3 edge point; a connection line between the No. 1 interior point and No. 3 corner point, a connection line between No. 2 interior point and the No. 1 edge point, and a connection line between the No. 2 interior point and No. 2 corner point;

if the initial line for division is the connection line between the No. 1 interior point and the No. 1 edge point, the second line for division is a connection line between the No. 1 interior point and No. 3 edge point, a connection line between the No. 1 interior point and No. 3 corner point, a connection line between No. 2 interior point and No. 2 edge point, and a connection line between the No. 2 interior point and the No. 2 corner point;

3-2-5) according to a type of the second line for division determined in step (3-2-4), the division mode of the quadrilateral areas and the rule in which the end points are numbered, determining a third line for division as follows:

if the second line for division is the connection line between the No. 1 interior point and the No. 3 corner point, the third line for division is a connection line between the No. 2 interior point and No. 5 edge point, or a connection line between the No. 2 interior point and No. 4 corner point;

if the second line for division is the connection line between the No. 2 interior point and the No. 1 corner point, the third line for division is a connection line between the No. 2 interior point and No. 5 edge point, a connection line between the No. 2 interior point and the No. 4 corner point, a connection line between No. 3 interior point and the No. 3 edge point, or a connection line between the No. 3 interior point and the No. 3 corner point;

if the second line for division is the connection line between the No. 1 interior point and the No. 3 edge point, the third line for division is a connection line between the No. 2 interior point and No. 4 edge point, or a connection line between the No. 2 interior point and the No. 3 corner point;

if the second line for division is the connection line between the No. 2 interior point and the No. 1 edge point, the third line for division is a connection line between the No. 2 interior point and the No. 3 edge point, a connection line between the No. 2 interior point and the No. 3 corner point, a connection line between the No. 3 interior point and the No. 2 edge point, or a connection line between the No. 3 interior point and the No. 2 corner point;

if the second line for division is the connection line between the No. 2 interior point and the No. 2 edge point, the third line for division is a connection line between the No. 2 interior point and the No. 3 edge point, a connection line between the No. 2 interior point and the No. 3 corner point, or a connection line between the No. 3 interior point and the No. 2 corner point;

3-2-6) according to a type of the last line for division determined in the previous step, the division mode of the quadrilateral areas and the rule in which the end points are numbered, determining a next line for division as follows:

if the last line for division pertains to the first-type connection line, and the last line for division and its previous line for division are connected to the same interior point, the next line for division is a connection line between No. (i+1) interior point and No. (2j−1) edge point, or a connection line between the No. (i+1) interior point and No. (j+1) corner point; wherein i and j are a sequence number of the first end point and a sequence number of the second end point of the last line for division, respectively;

if the last line for division is the first-type connection line, and the last line for division and its previous line for division are connected to different interior points, the next line for division is a connection line between No. i interior point and No. (2j+1) edge point, a connection line between the No. i interior point and No. (j+2) corner point, a connection line between the No. (i+1) interior point and the No. (2j−1) edge point, or a connection line between the No. (i+1) interior point and the No. (j+1) corner point; wherein i and j are the sequence number of the first end point and the sequence number of the second end point of the last line for division, respectively;

if the last line for division pertains to the second-type connection line, and the last line for division and its previous line for division are connected to the same interior point, the next line for division is a connection line between the No. (1+1) interior point and No. (j+1) edge point, or a connection line between the No. (1+1) interior point and No. (1+3)/2 corner point; wherein i and j are the sequence number of the first end point and the sequence number of the second end point of the last line for division, respectively;

if the last line for division is the second-type connection line, and the last line for division and its previous line for division are connected to different interior points, the next line for division is a connection line between the No. i interior point and No. (j+2) edge point, a connection line between the No. i interior point and No. (j+5)/2 corner point, a connection line between the No. (1+1) interior point and the No. (j+1) edge point, or a connection line between the No. (1+1) interior point and the No. (j+3)/2 corner point; wherein i and j are the sequence number of the first end point and the sequence number of the second end point of the last line for division, respectively;

if the last line for division is the third-type connection line, the next line for division is a connection line between the No. i interior point and No. 0+1) edge point, a connection line between the No. i interior point and No. (j+4)/2 corner point, or a connection line between the No. (i+1) interior point and the No. (j+2)/2 corner point; wherein i and j are the sequence number of the first end point and the sequence number of the second end point of the last line for division, respectively;

3-2-7) determining whether the sequence number of end points of the next line for division determined in step (3-2-6) is out of limit; wherein if the sequence number of the end points satisfies one of the following conditions, the sequence number of the end points is determined to be out of limit, and the next line for division is deleted:

a) the sequence number of the first end point is greater than 4;

b) the second end point is the corner point, and the sequence number of the second end point is greater than n;

c) the second end point is an odd-numbered edge point, and the sequence number of the second end point is greater than (m−1); and

d) the second end point is an even-numbered edge point, and the sequence number of the second end point is greater than m;

3-2-8) determining the next line for division according to steps (3-2-6)-(3-2-7) until the sequence number of the first end point is equal to 4, and the sequence number of the second end point of the last line for division satisfies any one of the following conditions:

if the last line for division is the first-type connection line, the sequence number of the second end point of the last line for division is equal to n;

if the last line for division is the second-type connection line, the sequence number of the second end point of the last line for division satisfies j+1=m; and if the last line for division is the third-type connection line, the sequence number of the second end point of the last line for division is equal to m; and 3-2-9) dividing the top surface into a plurality of quadrilateral areas and determining corresponding division mode according to the type of the lines for division determined above.

In an embodiment, the step of optimizing the average quality of the quadrilateral areas using the fruit fly optimization algorithm in step (4) comprises:

4-1) initializing a population size, an iteration number and a flying radius of fruit flies;

4-2) obtaining a linear equation of each edge of the top surface according to coordinates of the corner points on the top surface;

4-3) assigning coordinates of the edge points and the interior points to first-generation fruit fly individuals to allow them to be randomly located on edges of the top surface and an interior of the top surface, respectively;

4-4) calculating the average qualities of the quadrilateral areas corresponding to the first-generation fruit fly individuals;

4-5) comparing the average qualities of the quadrilateral areas corresponding to the first-generation fruit fly individuals, and reserving the maximum value of the average qualities of the quadrilateral areas and corresponding coordinates of the interior points and edge points;

4-6) assigning coordinates of the interior points and edge points to fruit fly individuals of a next generation to allow the fruit fly individuals of the next generation to be randomly distributed in a circle with the reserved interior points and the reserved edge points as a center and the flying radius as a radius;

4-7) calculating the average qualities of the quadrilateral areas corresponding to the fruit fly individuals in step (4-6);

4-8) comparing the average qualities of the quadrilateral areas corresponding to the fruit fly individuals, and reserving the maximum value of the average qualities of the quadrilateral areas and corresponding coordinates of the interior points and the edge points;

4-9) comparing the maximum value of the average qualities of the quadrilateral areas obtained in step (4-8) with the maximum value of the average qualities of the quadrilateral areas reserved in step (4-5) to obtain and reserve a larger value of the average qualities of the quadrilateral areas and corresponding coordinates of the interior points and the edge points;

4-10) repeating steps (4-6)-(4-9) until the number of running reaches the iteration number of the fruit flies; and

4-11) obtaining a final maximum value of the average qualities of the quadrilateral areas and corresponding coordinates of the interior points and the edge points.

In an embodiment, in step (4-4) or step (4-7), the average qualities of the quadrilateral areas are calculated as follows:

$$q\_average = {\sum }_{i = 0}^{l} {q}_{i} / l , \qquad ( 1 )$$

wherein q_average represents the average quality of the quadrilateral areas in a certain division mode; l represents the number of the quadrilateral areas in the division mode; and qᵢ represents a quality value of an i-th quadrilateral area.

In an embodiment, the average quality of the quadrilateral areas is calculated by steps of:

1) supposing that sequence numbers of vertices of the i-th quadrilateral area are 1, 2, 3, and 4, and vertical coordinates of the vertices of the i-th quadrilateral area are 0; calculating mixed products a, b, and c according to the following expressions:

a=[\vec{23}\vec{24}\vec{(0,0,1)}][\vec{23}\vec{21}\vec{(0,0,1)}] (2),

b=[\vec{12}\vec{13}\vec{(0,0,1)}][\vec{12}\vec{14}\vec{(0,0,1)}] (3),

c=[\vec{13}\vec{12}\vec{(0,0,1)}][\vec{13}\vec{14}\vec{(0,0,1)}] (4),

wherein each vector is a three-dimensional vector;

2) determining a type of the i-th quadrilateral area according to the mixed products a, b and c:

if a>0, b>0 and c<0, the i-th quadrilateral area is a convex quadrilateral;

if a>0, b<0 and c<0; a>0, b>0 and c>0; a<0, b>0 and c<0; or a<0 and b<0, the i-th quadrilateral area is a concave quadrilateral area; and

if a>0, b<0 and c>0; or a<0, b>0 and c>0, the vertices of the i-th quadrilateral area are crossed;

3) determining the quality value of the i-th quadrilateral area according to the type of the i-th quadrilateral area and the following expressions:

$${q}_{i} = \\ \{ \begin{matrix}{J}_{R} & ( when the i - th quadrilateral area is a convex quadrilateral ) \\ x & ( when the i - th quadrilateral area is a concave quadrilateral ) \\ y & ( when the vertexes of thei - th quadrilateral area are crossed )\end{matrix} , \qquad ( 5 )$$

wherein x and y are self-set penalty coefficients, and y<x<0; J_{R} is a ratio of a minimum value to a maximum value of Jacobian corresponding to each integration point of the i-th quadrilateral area, and a calculation formula of J_{R} is:

$${J}_{R} = \frac{{\vert J \vert}_{min}}{{\vert J \vert}_{max}} , \qquad ( 6 )$$

wherein |J| min is the minimum value of the Jacobian corresponding to each integration point of the i-th quadrilateral area; |J|ₘₐₓ is the maximum value of Jacobian corresponding to each integration point of the i-th quadrilateral area; based on the coordinates of each vertex of the i-th quadrilateral area, the Jacobian corresponding to each integration point of the i-th quadrilateral area is calculated as follows:

|J|₁=(x₂−x₁)(y₄−y₁)−(x₄−x₁)(y₂−y₁) (7),

|J|₂=(x₃−x₂)(y₁−y₂)−(x₁−x₂)(y₃−y₂) (8),

|J|₃=(x₄−x₂)(y₂−y₃)−(x₂−x₃)(y₄−y₃) (9),

|J|₄=(x₁−x₄)(y₃−y₄)−(x₃−x₄)(y₁−y₄) (10),

wherein x₁−x₄ are the abscissas of the vertices of the i-th quadrilateral area, and y₁−y₄ are the ordinates of the vertices of the i-th quadrilateral area.

In an embodiment, the step of subjecting the columnar models to structured meshing through a sweep method in step (6) comprises:

6-1) dividing the top surface into a plurality of quadrilateral areas according to the optimal division mode obtained in step (5); and dividing the model of the rotor bar into corresponding number of columnar models with the quadrilateral top surfaces according to the quadrilateral areas;

6.2) determining an initial size of meshes of the columnar models as follows:

$$V = \sqrt[\frac{3}{2}]{\frac{S}{i}} , \qquad ( 11 )$$

wherein V is the initial size of meshes of the columnar models; S is the area of the top surface; and i is the number of quadrilateral areas on the top surface;

6-3) meshing the columnar models according to the initial size of meshes of the columnar models determined in step (6-2) using the sweep method;

6-4) performing thermal analysis on the finite element models after the meshing to obtain a thermal distribution of the columnar models, and selecting a temperature at any point on the model;

6-5) reducing a size of the meshes to half of the size of the meshes in previous meshing, and meshing the columnar models using the sweep method in step (6-3);

6-6) performing the thermal analysis on the finite element models after the meshing in step (6-5) to obtain the temperature at the same point as in step (6-4);

6-7) comparing the temperature obtained in step (6-6) with the temperature of the same point obtained in the previous thermal analysis to obtain a temperature deviation ΔTᵢ:

ΔTᵢ=|Tᵢ−T₍ᵢ₋₁₎| (12),

wherein Tᵢ is the temperature of the certain point on the model obtained from this thermal analysis; T₍ᵢ₋₁₎ is the temperature of the same point on the model obtained from the previous thermal analysis;

6-8) determining whether the temperature deviation ΔTᵢ is within a preset threshold range:

ΔTᵢ≤ΔT_{M} (13),

wherein ΔT_{M} is the preset threshold of the temperature deviation ΔTᵢ;

if the temperature deviation is within the preset threshold range, proceeding to the next step; otherwise, returning to step (6-5);

6-9) adopting the obtained meshes as the optimal structured meshing result of the columnar models.

In the present invention, a quadrilateral is randomly added within the top surface of the thermal analysis model of the rotor bar. The polygonal top surface is divided into a plurality of quadrilateral areas by drawing a line from each vertex of the quadrilateral to each vertex of the top surface or two points selected randomly on each edge of the top surface, respectively, and corresponding division modes are obtained. Then, for each of the division modes, the average quality of the quadrilateral areas is optimized using a fruit fly optimization algorithm, to obtain a maximum value of the average quality of the quadrilateral areas in a division mode and corresponding coordinates of the vertices of the quadrilateral areas. The top surface is divided into a plurality of quadrilateral areas according to the division mode corresponding to the maximum average quality to divide the model of the rotor bar into a plurality of columnar models having quadrilateral top surfaces. Finally, structured meshes are generated for the columnar models through a sweep method to obtain an optimal structured meshing result for the model of the rotor bar.

The present invention has the following advantages. The complex model with polygonal top surface can be divided into several simple models with quadrangular top surfaces, which reduces the time for meshing. In addition, the quadrilateral areas can obtain the highest average quality through the optimizing algorithm, which effectively improves the overall meshing quality, thereby improving the accuracy of thermal analysis of the AC motor.

### BRIEF DESCRIPTION OF THE DRAWINGS

FIG. 1 is a flow chart of a method for optimizing structured mesh generation for a thermal analysis model of a rotor bar of an AC motor according to an embodiment of the present disclosure.

FIG. 2 is a flow chart of a method for dividing a polygonal top surface of the thermal analysis model of a rotor bar of an AC motor into quadrilateral areas according to an embodiment of the present disclosure.

FIG. 3 is a flow chart of a method for optimizing an average quality of the quadrilateral areas using a fruit fly optimization algorithm according to an embodiment of the present disclosure.

FIG. 4 is a flow chart of a method for structured mesh generation of columnar models using a sweep method according to an embodiment of the present disclosure.

FIG. 5 is a schematic diagram of a dimension of a top surface of a rotor bar of a Y100L2-4 AC motor according to an embodiment of the present disclosure.

FIG. 6 shows sequence numbers of corner points and edge points of the top surface of the rotor bar of the Y100L2-4 AC motor according to an embodiment of the present disclosure.

FIG. 7 is a curve showing an optimization process of the average quality of the quadrilateral areas using the fruit fly optimization algorithm according to an embodiment of the present disclosure.

FIG. 8 is a schematic diagram of optimal division areas of the top surface of the model of the rotor bar according to an embodiment of the present disclosure.

FIG. 9 is a schematic diagram of optimal structured meshes of the model of the rotor bar according to an embodiment of the present disclosure.

### DETAILED DESCRIPTION OF EMBODIMENTS

The present disclosure will be further described in detail below with reference to the accompanying drawings and the embodiments.

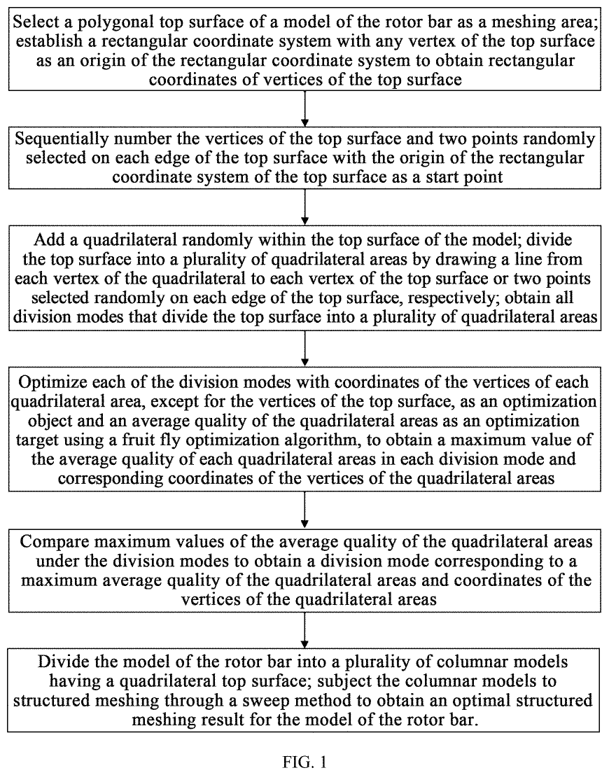

Referring to FIG. 1, the present disclosure provides a method for optimizing structured mesh generation for a thermal analysis model of a rotor bar of an AC motor, including the following steps.

1) A polygonal top surface of a model of the rotor bar is selected as a meshing area. A rectangular coordinate system with any vertex of the top surface as an origin of the rectangular coordinate system is established to obtain rectangular coordinates of vertices of the top surface.

2) The vertices of the top surface and two points randomly selected on each side of the top surface are sequentially numbered with the origin of the rectangular coordinate system of the top surface as a start point. The rule for numbering is described as follows.

2-1) For convenience, the vertices of the top surface are taken as corner points, and the two points randomly selected on each edge of the top surface are taken as edge points.

2-2) The corner points and the edge points are numbered separately.

2-3) A corner point where the origin of the rectangular coordinate system is located is taken as No. 1 corner point, and the corner points are sequentially numbered in a clockwise or counterclockwise direction.

2-4) The edge points are numbered in a direction along which the corner points are numbered. A first edge point encountered by the No. 1 corner point in the numbering direction of the corner points are numbered as No. 1 edge point, and the edge points are sequentially numbered.

3) A quadrilateral is randomly added within the top surface of the model. The top surface is divided into a plurality of quadrilateral areas by drawing a line from each vertex of the quadrilateral to each vertex of the top surface or two points selected randomly on each edge of the top surface, respectively, and all division modes that divide the top surface into a plurality of quadrilateral areas are obtained.

Before the top surface is divided into several quadrilateral areas, vertices of the added quadrilateral on the top surface are required to be numbered. The rule for numbering the vertices of the added quadrilateral is described as follows. For convenience, the vertices of the quadrilateral are taken as interior points. An interior point is randomly taken as No. 1 interior point, and the interior points are sequentially numbered in the direction along which the corner points are numbered.

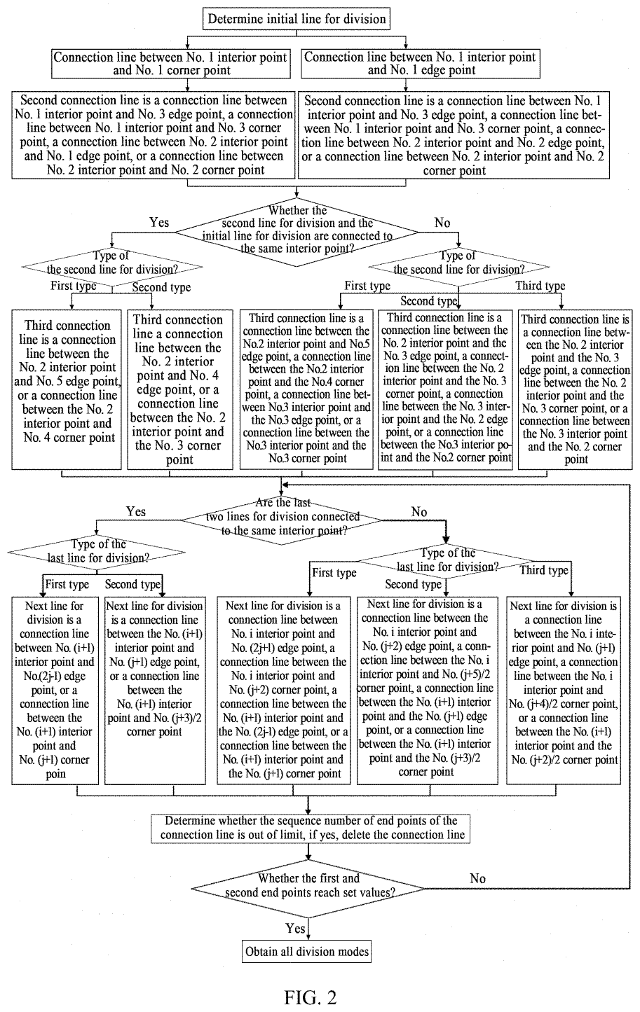

Referring to FIG. 2, the step of dividing the top surface into a plurality of quadrilateral areas includes the following steps.

3-2-1) Connection lines between interior points and corner points are taken as first-type connection lines. Connection lines between the interior points and an odd-numbered edge point of the edge points are taken as second-type connection lines. Connection lines between the interior points and an even-numbered edge point of the edge points are taken as third-type connection lines. The interior points in the first-type, second-type and third-type connection lines are taken as a first end; and the corner point, the odd-numbered edge point and the even-numbered edge point respectively in the first-type, second-type and third-type connection lines are taken as a second end;

3-2-2) The number of the corner points of the top surface is set as n, and the number of the edge points of the top surface is set as m and m=2n.

3-2-3) A first line for division, i.e., an initial line for division, is determined. The initial line for division is a connection line between No. 1 interior point and No. 1 corner point or a connection line between the No. 1 interior point and No. 1 edge point.

3-2-4) According to a type of the connection line for division, the division mode of the quadrilateral areas and a rule in which the end points are numbered, a second line for division is determined as follows:

If the initial line for division is the connection line between the No. 1 interior point and the No. 1 corner point, the second connection line is a connection line between the No. 1 interior point and No. 3 edge point, a connection line between the No. 1 interior point and No. 3 corner point, a connection line between No. 2 interior point and the No. 1 edge point, or a connection line between the No. 2 interior point and No. 2 corner point.

If the initial line for division is the connection line between the No. 1 interior point and the No. 1 edge point, the second connection line is a connection line between the No. 1 interior point and No. 3 edge point, a connection line between the No. 1 interior point and No. 3 corner point, a connection line between No. 2 interior point and No. 2 edge point, or a connection line between the No. 2 interior point and No. 2 corner point.

3-2-5) According to a type of the second line for division determined in step (3-2-4), the division mode of the quadrilateral areas and the rule in which the end points are numbered, a third line for division is determined as follows.

If the second line for division is the connection line between the No. 1 interior point and the No. 3 corner point, the third line for division is a connection line between the No. 2 interior point and No. 5 edge point, or a connection line between the No. 2 interior point and No. 4 corner point.

If the second line for division is the second connection line is the connection line between the No. 2 interior point and the No. 2 corner point, the third line for division is a connection line between the No. 2 interior point and No. 5 edge point, a connection line between the No. 2 interior point and the No. 4 corner point, a connection line between No. 3 interior point and the No. 3 edge point, or a connection line between the No. 3 interior point and the No. 3 corner point.

If the second line for division is the connection line between the No. 1 interior point and the No. 3 edge point, the third line for division is a connection line between the No. 2 interior point and No. 4 edge point, or a connection line between the No. 2 interior point and the No. 3 corner point.

If the second line for division is the connection line between the No. 2 interior point and the No. 1 edge point, the third line for division is a connection line between the No. 2 interior point and the No. 3 edge point, a connection line between the No. 2 interior point and the No. 3 corner point, a connection line between the No. 3 interior point and the No. 2 edge point, or a connection line between the No. 3 interior point and the No. 2 corner point.

If the second line for division is the connection line between the No. 2 interior point and the No. 3 edge point, the third line for division is a connection line between the No. 2 interior point and the No. 3 edge point, a connection line between the No. 2 interior point and the No. 3 corner point, or a connection line between the No. 3 interior point and the No. 2 corner point.

3-2-6) According to a type of the last line for division determined in the previous step, the division mode of the quadrilateral areas and the rule in which the end points are numbered, a next line for division is determined as follows.

If the last line for division pertains to the first-type connection line, and the last line for division and its previous line for division are connected to the same interior point, the next line for division is a connection line between No. (i+1) interior point and No. (2j-1) edge point, or a connection line between the No. (i+1) interior point and No. (j+1) corner point; where i and j are a sequence number of the first end point and a sequence of the second end point of the last line for division, respectively.

If the last line for division pertains to the first-type connection line, and the last line for division and its previous line for division are connected to different interior points, the next line for division is a connection line between No. i interior point and No. (2j+1) edge point, a connection line between the No. i interior point and No. (j+2) corner point, a connection line between the No. (i+1) interior point and the No. (2j−1) edge point, or a connection line between the No. (i+1) interior point and the No. (j+1) corner point; where i and j are the sequence number of the first end point and the sequence number of the second end point of the last line for division.

If the last line for division pertains to the second-type connection line, and the last line for division and its previous line for division are connected to the same interior point, the next line for division is a connection line between the No. (1+1) interior point and No. (j+1) edge point, or a connection line between the No. (i+1) interior point and No. (j+3)/2 corner point; where i and j are the sequence number of the first end point and the sequence number of the second end point of the last line for division, respectively.

If the last line for division pertains to the second-type connection line, and the last line for division and its previous line for division are connected to different interior points, the next line for division is a connection line between the No. i interior point and No. (j+2) edge point, a connection line between the No. i interior point and No. (j+5)/2 corner point, a connection line between the No. (i+1) interior point and the No. (j+1) edge point, or a connection line between the No. (i+1) interior point and the No. (j+3)/2 corner point; where i and j are the sequence number of the first end point and the sequence number of the second end point of the last line for division, respectively.

If the last line for division pertains to the third-type connection line, the next line for division is a connection line between the No. i interior point and No. (j+1) edge point, a connection line between the No. i interior point and No. (j+4)/2 corner point, or a connection line between the No. (i+1) interior point and the No. (j+2)/2 corner point; where i and j are the sequence number of the first end point and the sequence number of the second end point of the last line for division, respectively.

3-2-7) Whether the sequence number of end points of the next line for division determined in step (3-2-6) is out of limit is determined. If the sequence number of the end points satisfies one of the following conditions, the sequence number of the end points is determined to be out of limit, and the next line for division is deleted:

a) the sequence number of the first end point is greater than 4;

b) the second end point is the corner point, and the sequence number of the second end point is greater than n;

c) the second end point is the odd-numbered edge point, and the sequence number of the second end point is greater than (m−1); and

d) the second end point is the even-numbered edge point, and the sequence number of the second end point is greater than m.

3-2-8) The next line for division is determined according to steps (3-2-6)-(3-2-7) until the sequence number of the first end point of the last connection line reaches set a value thereof, i.e., the sequence number of the first end point is equal to 4, and the sequence number of the second end point of the last line for division satisfies any one of the following conditions:

if the last line for division is the first-type connection line, the sequence number of the second end point of the last line for division is equal to n, i.e., j=n;

if the last line for division is the second-type connection line, the sequence number of the second end point of the last line for division satisfies j+1=m; and

if the last line for division is the third-type connection line, the sequence number of the second end point of the last line for division is equal to m, i.e., j=m.

3-2-9) The top surface is divided into a plurality of quadrilateral area, and a corresponding division mode is determined according to the type of the connection line determined in previous steps.

4) Each of the division modes is optimized with coordinates of the vertices of the quadrilateral areas, except for the vertices of the top surface, as an optimization object, and an average quality of the quadrilateral areas as an optimization target using a fruit fly optimization algorithm, to obtain a maximum value of the average quality of each quadrilateral areas in each division mode and corresponding coordinates of the vertices of the quadrilateral areas.

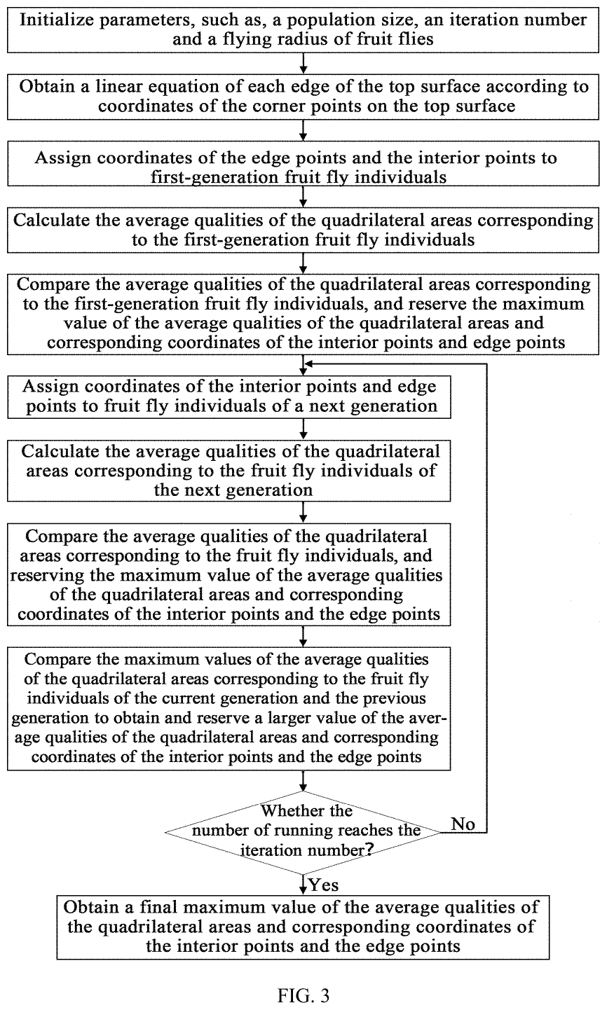

FIG. 3 is a flow chart of a method for optimizing an average quality of the quadrilateral areas using a fruit fly optimization algorithm, including the following steps.

4-1) A population size, an iteration number and a flying radius of fruit flies are initialized.

4-2) A linear equation of each edge of the top surface is obtained according to coordinates of the corner points on the top surface. Specifically, the method is described as follows.

Supposing that the coordinates of two adjacent corner points are (x₁,y₁) and (x₂,y₂), the linear equation formed by the connection line of the two points is:

ax+by+c=0 (1),

where, a, b, and c respectively represent coefficients of the linear equation, and the calculation formulas thereof are as follows:

$$\begin{matrix}\{ \begin{matrix}a = \frac{{y}_{1} - {y}_{2}}{{x}_{1} - {x}_{2}} \\ b = - 1 \\ c = {y}_{1} - {ax}_{1}\end{matrix} , & ( 2 ) \\ \{ \begin{matrix}a = 1 \\ b = 0 \\ c = - {x}_{1}\end{matrix} , & ( 3 )\end{matrix}$$

where, formula (2) is the calculation formula for the coefficients of the equation when the slope of the linear line exists, and formula (3) is the calculation formula for the coefficients of the equation when the slope of the linear line does not exist.

4-3) Coordinates of the edge points and the interior points are assigned to first generation fruit fly individuals to allow the first generation fruit fly individuals to be randomly located on edges of the top surface and an interior of the top surface, respectively.

The coordinates of the edge points of the first-generation fruit fly individuals are obtained by the following formulas:

$$\begin{matrix}\{ \begin{matrix}{x}_{3} = ( {x}_{2} - {x}_{1} ) * random . random ( ) + {x}_{1} \\ {y}_{3} = \frac{- a {x}_{3} - c}{b} \\ {x}_{4} = ( {x}_{2} - {x}_{3} ) * random . random ( ) + {x}_{3} \\ {y}_{4} = \frac{- a {x}_{4} - c}{b}\end{matrix} , & ( 4 ) \\ \{ \begin{matrix}{y}_{3} = ( {y}_{2} - {y}_{1} ) * random . random ( ) + {y}_{1} \\ {x}_{3} = - \frac{c}{a} \\ {y}_{4} = ( {y}_{2} - {y}_{3} ) * random . random ( ) + {y}_{3} \\ {x}_{4} = - \frac{c}{a}\end{matrix} , & ( 5 )\end{matrix}$$

where, formula (4) is the calculation formula for the coordinates of the edge points when the slope of the linear line where the edge point is located exists, and formula (5) is the calculation formula for the coordinates of the edge points when the slope of the linear line where the edge point is located does not exist; (x₁, y₁), (x₂, y₂) are the coordinates of two adjacent corner points, (x₃, y₃) are coordinate of the odd-numbered edge point on the edge between the above two adjacent corner points, (x₄, y₄) are the coordinate of the even-numbered edge point on the edge; random.random( )is a random number in [0,1]; and a, b, and c are the coefficients of the linear equation ax+by+c=0 of the edge obtained in step (4-2).

The coordinates of the interior points of the first generation fruit fly individuals are obtained by the following formula:

$$\{ \begin{matrix}x = ( {x}_{max} - {x}_{min} ) * random . random ( ) + {x}_{min} \\ y = ( {y}_{max} - {y}_{min} ) * random . random ( ) + {y}_{min}\end{matrix} , \qquad ( 6 )$$

where, (x, y) is the coordinate of the interior point, xₘₐₓ, xₘᵢₙ, yₘₐₓ, and yₘᵢₙ are the maximum and minimum values of the horizontal and vertical coordinates of each corner point of the top surface, respectively; and random.random( )is a random number in [0,1].

4-4) The average qualities of the quadrilateral areas corresponding to the first-generation fruit fly individuals are calculated as follows.

1) Supposing that sequence numbers of vertices of the i-th quadrilateral area are 1, 2, 3, and 4, and vertical coordinates of the vertices of the i-th quadrilateral area are 0, mixed products a, b, and c are calculated according to the following expressions:

a=[\vec{23}\vec{24}\vec{(0,0,1)}][\vec{23}\vec{21}\vec{(0,0,1)}] (7),

b=[\vec{12}\vec{13}\vec{(0,0,1)}][\vec{12}\vec{14}\vec{(0,0,1)}] (8),

c=[\vec{13}\vec{12}\vec{(0,0,1)}][\vec{13}\vec{14}\vec{(0,0,1)}] (9),

where, each vector is a three-dimensional vector.

2) The type of the i-th quadrilateral area is determined according to the mixed products a, b and c:

if a>0, b>0 and c<0, the i-th quadrilateral area is a convex quadrilateral;

if a>0, b<0 and c<0; a>0, b>0 and c>0; a<0, b>0 and c<0; or a<0 and b<0, the i-th quadrilateral area is a concave quadrilateral area; and

if a>0, b<0 and c>0; or a<0, b>0 and c>0, the vertices of the i-th quadrilateral area are crossed.

3) The quality value of the i-th quadrilateral area is determined according to the type of the i-th quadrilateral area and the following expressions:

$${q}_{i} = \{ \begin{matrix}{J}_{R} & ( when the i - th quadrilateral area is a convex quadrilateral ) \\ x & ( when the i - th quadrilateral area is a concave quadrilateral ) \\ y & ( when the vertexes of thei - th quadrilateral area are crossed )\end{matrix} , \qquad ( 10 )$$

where, x and y are the self-set penalty coefficients, and y<x<0; J_{R} is the ratio of a minimum value to a maximum value of Jacobian corresponding to each integration point of the i-th quadrilateral area, and a calculation formula of J_{R} is:

$${J}_{R} = \frac{{\vert J \vert}_{min}}{{\vert J \vert}_{max}} , \qquad ( 11 )$$

where, |J|ₘᵢₙ is the minimum value of the Jacobian corresponding to each integration point of the i-th quadrilateral area; |J|ₘₐₓ is the maximum value of Jacobian corresponding to each integration point of the i-th quadrilateral area. Based on the coordinates of each vertex of the i-th quadrilateral area, the Jacobian corresponding to each integration point of the i-th quadrilateral area is calculated as follows:

|J|₁=(x₂−x₁)(y₄−y₁)−(x₄−x₁)(y₂−y₁) (12),

|J|₂=(x₃−x₂)(y₁−y₂)−(x₁−x₂)(y₃−y₂) (13),

|J|₃=(x₄−x₂)(y₂−y₃)−(x₂−x₃)(y₄−y₃) (14),

|J|₄=(x₁−x₄)(y₃−y₄)−(x₃−x₄)(y₁−y₄) (15),

where, x₁−x₄ are the abscissas of the vertices of the i-th quadrilateral area, and y₁−y₄ are the ordinates of the vertices of the i-th quadrilateral area.

4-5) The average qualities of the quadrilateral areas corresponding to the first-generation fruit fly individuals are compared, and the maximum value of the average qualities of the quadrilateral areas and corresponding coordinates of the interior points and edge points are reserved.

4-6) Coordinates of the interior points and edge points are assigned to next generation fruit fly individuals, in which the next-generation fruit fly individuals are randomly distributed in a circle with the reserved interior points and the reserved edge points as a center and the flying radius as a radius.

The formula for calculating coordinates of the interior points of the next generation fruit fly individuals is as follows:

$$\{ \begin{matrix}x = neidian\_axis [ 0 ] + R * ( 2 * random . random ( ) - 1 ) \\ y = neidian\_axis [ 1 ] + R * ( 2 * random . random ( ) - 1 )\end{matrix} , \qquad ( 16 )$$

where, (x, y) are the coordinate of the interior points of the next generation fruit fly individuals; neidian_axis[0] and neidian_axis[1] are the abscissa and the ordinate of the interior points reserved in the previous step; R is the flying radius of the fruit fly individuals; and random.random( )is a random number in [0,1].

The formula for calculating the coordinates of the edge points of the next generation fruit fly individuals is as follows:

$$\{ \begin{matrix}x = biandian\_axis [ 0 ] + R * ( 2 * random . random ( ) - 1 ) \\ y = biandian\_axis [ 1 ] + R * ( 2 * random . random ( ) - 1 )\end{matrix} , \qquad ( 17 )$$

where, (x, y) are the coordinate of the edge points of the next generation fruit fly individuals; biandian_axis[0] and biandian_axis[1] are the abscissa and the ordinate of the edge points reserved in the previous step; R is the flying radius of the fruit fly individuals; and random.random( )is a random number in [0,1].

4-7) The average qualities of the quadrilateral areas corresponding to the fruit fly individuals in step (4-6) are calculated.

4-8) The average qualities of the quadrilateral areas corresponding to the fruit fly individuals are compared, and the maximum value of the average qualities of the quadrilateral areas and corresponding coordinates of the interior points and the edge points are reserved.

4-9) The maximum value of the average qualities of the quadrilateral areas obtained in step (4-8) is compared with the maximum value of the average qualities of the quadrilateral areas reserved in step (4-5) to obtain and reserve a larger value of the average qualities of the quadrilateral areas and corresponding coordinates of the interior points and the edge points.

4-10) Steps (4-6)-(4-9) are repeated until the number of running reaches the iteration number of the fruit flies.

4-11) A final maximum value of the average qualities of the quadrilateral areas and corresponding coordinates of the interior points and the edge points are obtained.

5) Maximum values of the average qualities of the quadrilateral areas in all the division modes are compared to obtain a division mode corresponding to a maximum average quality of the quadrilateral areas and the coordinates of the vertices of the quadrilateral areas corresponding to the maximum average quality of the quadrilateral areas. The division mode corresponding to the maximum average quality of the quadrilateral areas is taken as an optimal division mode.

6) The model of the rotor bar is divided into a plurality of columnar models with quadrilateral top surfaces according to the optimal division mode obtained in step (5). Structured meshes are generated for the columnar models through a sweep method to obtain an optimal structured meshing result for the model of the rotor bar.

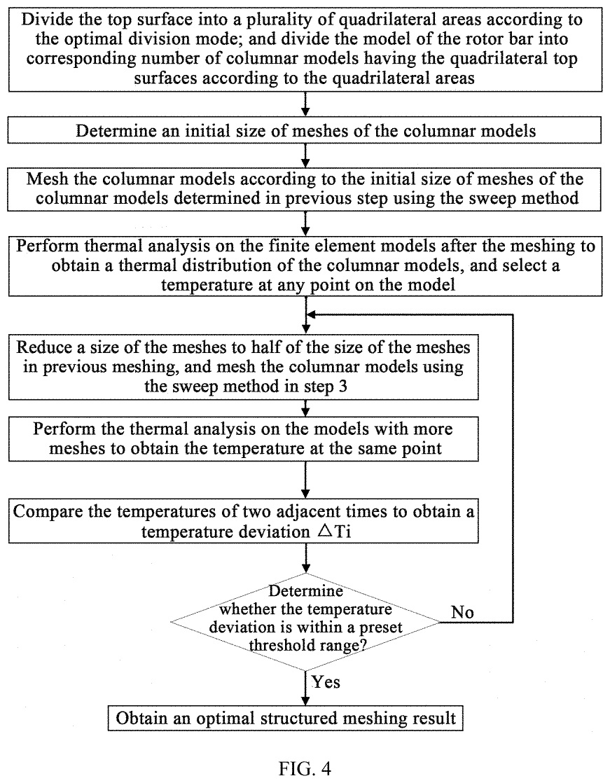

FIG. 4 is a flow chart of a method for structured mesh generation of columnar models using a sweep method, including the following steps.

6-1) The top surface is divided into a plurality of quadrilateral areas according to the optimal division mode obtained in step (5). Then, the model of the rotor bar is divided into corresponding number of columnar models with the quadrilateral top surfaces according to the quadrilateral areas.

6.2) An initial size of meshes of the columnar models is determined as follows:

$$V = \sqrt[\frac{3}{2}]{\frac{S}{i}} , \qquad ( 18 )$$

where, V is the initial size of meshes of the columnar models; S is the area of the top surface; and i is the number of quadrilateral areas on the top surface.

6-3) Columnar models are meshed according to the initial size of meshes of the columnar models determined in step (6-2) using the sweep method.

6-4) Thermal analysis is performed on the meshed finite element models to obtain a thermal distribution of the columnar models, and a temperature at any point on the model is selected.

6-5) A size of the meshes is reduced to half of the size of the meshes in previous meshing, and the columnar models are meshed using the sweep method in step (6-3).

6-6) The thermal analysis is performed on the finite element models after the meshing in step (6-5) to obtain the temperature at the same point as in step (6-4).

6-7) The temperature obtained in step (6-6) is compared with the temperature of the same point obtained in the previous thermal analysis to obtain a temperature deviation ΔTᵢ:

ΔTᵢ=|Tᵢ−T₍ᵢ₋₁₎| (19),

where, Tᵢ is the temperature of the certain point on the model obtained from this thermal analysis; T₍ᵢ₋₁₎ is the temperature of the same point on the model obtained from the previous thermal analysis.

6-8) Whether the temperature deviation ΔTᵢ obtained in step (6-7) is within a preset threshold range is determined:

ΔTᵢ≤ΔT_{M} (20),

where, ΔT_{M} is the preset threshold of the temperature deviation ΔTᵢ.

If the temperature deviation ΔTᵢ is within the preset threshold range, proceed to the next step; otherwise, return to step (6-5).

6-9) The obtained meshes are adopted as the optimal structured meshing result of the columnar models.

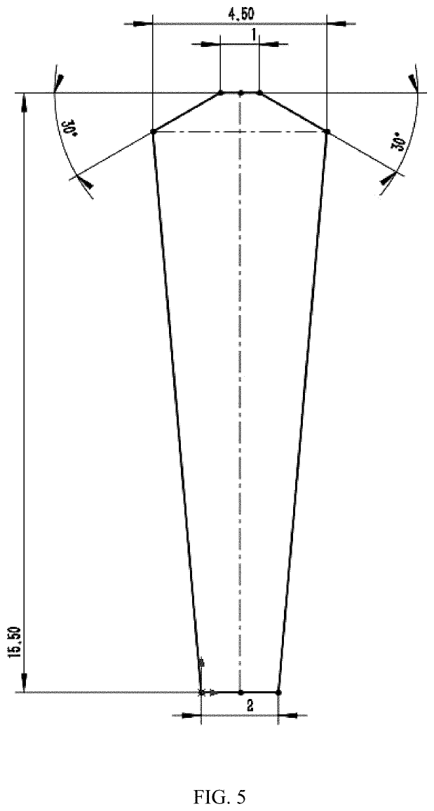

In this embodiment, a Y100L2-4 AC motor is adopted to further illustrate technical solutions of the present disclosure. FIG. 5 is a schematic diagram of a dimension of a top surface of a rotor bar of the Y100L2-4 AC motor according to an embodiment of the present disclosure. The top surface of the rotor bar is hexagonal. Steps of this embodiment are described as follows based on the dimensions shown in FIG. 5.

1) The hexagonal top surface of the rotor bar shown in FIG. 5 is selected as a meshing area, and a rectangular coordinate system is established with a vertex (as shown in FIG. 5) as the origin of the rectangular coordinate system of the top surface. According to the dimensions shown in FIG. 5, the rectangular coordinates of the vertices of the top surface are (0, 0), (2, 0), (3.25, 14.4896), (1.5, 15.5), (0.5, 15.5), (−1.25, 14.4896), respectively.

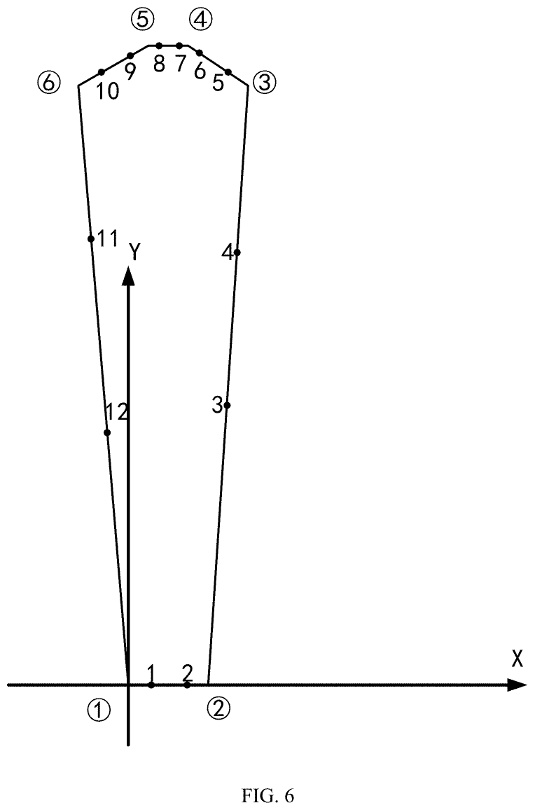

2) As shown in FIG. 6, the corner points and the edge points are separately numbered in the counterclockwise direction. The sequence numbers \hat{1}, \hat{2}, \hat{3}, \hat{4}, \hat{5} and \hat{6} indicate the corner points, and the remaining sequence numbers indicate the edge points.

3) A quadrilateral is randomly added on the top surface of the model. The top surface is divided into a plurality of quadrilateral areas by drawing a line from each vertex of the quadrilateral to each vertex of the top surface or two points randomly selected on each edge of the top surface, and all division modes that divide the top surface into a plurality of quadrilateral areas.

4) Each of the division modes is optimized using a fruit fly optimization algorithm with coordinates of the vertices of each quadrilateral area, except for the vertices of the top surface, as an optimization object and an average quality of the quadrilateral areas as an optimization target, to obtain a maximum value of the average quality of the quadrilateral areas in a division mode and corresponding coordinates of the vertices of the quadrilateral areas.

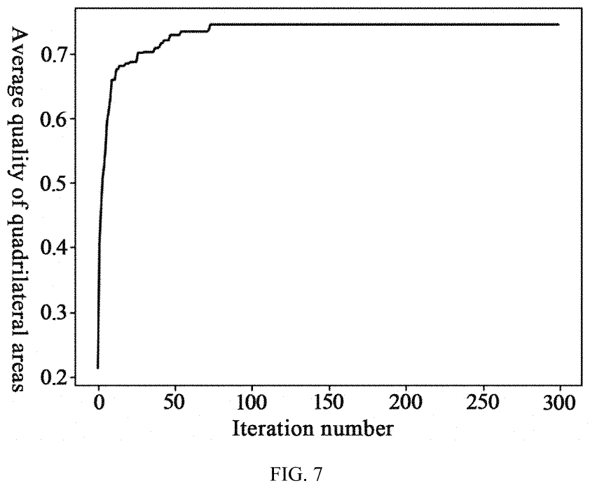

Relevant parameters of the above fruit fly optimization algorithm are set as follows: a population size of the fruit fly swarm is 5000; the maximum iteration number is 300; and the flying radius R of fruit fly individuals is 0.2. The optimization process is shown in FIG. 7. It can be seen that the average quality of the quadrilateral areas basically reaches its maximum value after the iteration number reaches about 75 times.

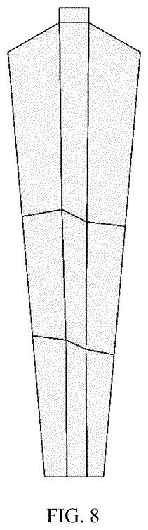

5) The maximum values of the average qualities in various division modes are compared to obtain an optimal division mode corresponding to the maximum average quality and the vertex coordinates of the quadrilateral areas. The division mode corresponding to the obtained maximum average quality is shown in FIG. 8, and the maximum average quality of the quadrilateral areas is 0.7309.

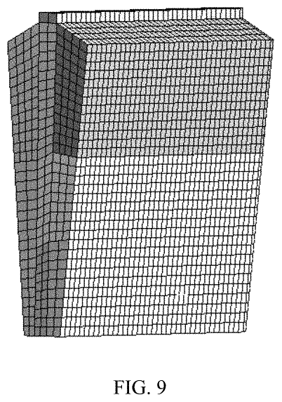

6) The model of the rotor bar is divided into a plurality of columnar models with quadrilateral top surfaces according to the optimal division mode obtained in step (5). Structured meshes for the columnar models are generated through a sweep method to obtain an optimal structured meshing result for the model of the rotor bar. The optimal structured meshing result is shown in FIG. 9.

The method for optimizing structured mesh generation for the thermal analysis model of the AC motor rotor bar of the present disclosure is compared with the traditional mesh generation method, and the related results are shown in Table 1. It can be seen that the method of the present disclosure significantly improves the minimum mesh and the average quality of meshes, thereby effectively improving the thermal analysis accuracy for the rotor bar of the AC motor.

TABLE 1

| | Average quality | Minimum quality |
|---|---|---|
| Traditional mesh | 0.91216 | 0.3115 |
| generation method | | |
| Optimized mesh | 0.93687 | 0.8556 |
| generation method | | |

What is claimed is:

1. A method for optimizing structured mesh generation for a thermal analysis model of a rotor bar of an alternating current (AC) motor, comprising:
1) selecting a polygonal top surface of a model of the rotor bar as a meshing area; establishing a rectangular coordinate system with any vertex of the top surface as an origin of the rectangular coordinate system to obtain rectangular coordinates of vertices of the top surface;
2) sequentially numbering the vertices of the top surface and two points randomly selected on each edge of the top surface with the origin of the rectangular coordinate system of the top surface as a start point;
3) adding a quadrilateral randomly within the top surface of the model; dividing the top surface into a plurality of quadrilateral areas by drawing a line from each vertex of the quadrilateral to each vertex of the top surface or two points selected randomly on each edge of the top surface, respectively; and obtaining all division modes that divide the top surface into a plurality of quadrilateral areas;
4) optimizing each of the division modes with coordinates of the vertices of each quadrilateral area except for the vertices of the top surface as an optimization object and an average quality of the quadrilateral areas as an optimization target using a fruit fly optimization algorithm, to obtain a maximum value of the average quality of each quadrilateral area in each division mode and corresponding coordinates of the vertices of the quadrilateral areas;
5) comparing maximum values of the average quality of the quadrilateral areas under the division modes to obtain a division mode corresponding to a maximum average quality of the quadrilateral areas and coordinates of vertices of the quadrilateral areas corresponding to the maximum average quality, wherein the division mode corresponding to the maximum average quality of the quadrilateral areas is taken as an optimal division mode; and
6) dividing the model of the rotor bar into a plurality of columnar models having a quadrilateral top surface according to the optimal division mode obtained in step (5); and subjecting the columnar models to structured meshing through a sweep method to obtain an optimal structured meshing result for the model of the rotor bar.

2. The method of claim 1, wherein the step of sequentially numbering the vertices of the top surface and the two points randomly selected on each edge of the top surface in step (2) comprises:
2-1) taking the vertices of the top surface as corner points, and taking the two points randomly selected on each edge of the top surface as edge points;
2-2) numbering the corner points and the edge points separately;
2-3) taking a corner point where the origin of the rectangular coordinate system is located as No. 1 corner point, sequentially numbering the corner points in a clockwise or counterclockwise direction; and
2-4) numbering the edge points in a direction along which the corner points are numbered, taking a first edge point encountered by the No. 1 corner point in the numbering direction of the corner points as No. 1 edge point, and sequentially numbering the edge points.

3. The method of claim 2, wherein in step (3), the vertices of the quadrilateral added in the top surface of the model are numbered by steps of:
3-1-1) taking the vertices of the quadrilateral as interior points; and
3-1-2) randomly selecting an interior point as No. 1 interior point, and sequentially numbering the remaining interior points in the direction along which the corner points are numbered.

4. The method of claim 3, wherein the step of dividing the top surface into a plurality of quadrilateral areas in step (3) comprises:
3-2-1) taking a connection line between each interior point and each corner point as a first-type connection line; taking a connection line between each interior point and each odd-numbered edge point as a second-type connection line; taking a connection line between each interior point and each even-numbered edge point as a third-type connection line; wherein the interior point in the first-type, second-type and third type connection lines are taken as a first end point, and the corner point, the odd-numbered edge point and the even-numbered edge point respectively in the first-type, second-type and third type connection lines are taken as a second end point;
3-2-2) setting the number of corner points of the top surface as n, the number of edge points of the top surface as m and m=2n;
3-2-3) determining an initial line for division wherein the initial line for division is a connection line between No. 1 interior point and No. 1 corner point or a connection line between the No. 1 interior point and No. 1 edge point;
3-2-4) according to a type of the initial line for division, the division mode of the quadrilateral areas and a rule in which the end points are numbered, determining a second line for division as follows:
if the initial connection line is the connection line between the No. 1 interior point and the No. 1 corner point, the second line for division is a connection line between the No. 1 interior point and No. 3 edge point, a connection line between the No. 1 interior point and No. 3 corner point, a connection line between No. 2 interior point and the No. 1 edge point or a connection line between the No. 2 interior point and No. 2 corner point;
if the initial line for division is the connection line between the No. 1 interior point and the No. 1 edge point, the second line for division is a connection line between the No. 1 interior point and the No. 3 edge point, a connection line between the No. 1 interior point and the No. 3 corner point, a connection line between the No. 2 interior point and No. 2 edge point or a connection line between the No. 2 interior point and the No. 2 corner point;
3-2-5) according to a type of the second line for division determined in step (3-2-4), the division mode of the quadrilateral areas and the rule in which the end points are numbered, determining a third line for division as follows:
if the second line for division is the connection line between the No. 1 interior point and the No. 3 corner point, the third line for division is a connection line between the No. 2 interior point and No. 5 edge point or a connection line between the No. 2 interior point and No. 4 corner point;
if the second line for division is the connection line between the No. 2 interior point and the No. 2 corner point, the third line for division is a connection line between the No. 2 interior point and No. 5 edge point, a connection line between the No. 2 interior point and the No. 4 corner point, a connection line between No. 3 interior point and the No. 3 edge point or a connection line between the No. 3 interior point and the No. 3 corner point;
if the second line for division is the connection line between the No. 1 interior point and the No. 3 edge point, the third line for division is a connection line between the No. 2 interior point and No. 4 edge point or a connection line between the No. 2 interior point and the No. 3 corner point;
if the second line for division is the connection line between the No. 2 interior point and the No. 1 edge point, the third line for division is a connection line between the No. 2 interior point and the No. 3 edge point, a connection line between the No. 2 interior point and the No. 3 corner point, a connection line between the No. 3 interior point and the No. 2 edge point or a connection line between the No. 3 interior point and the No. 2 corner point; and
if the second line for division is the connection line between the No. 2 interior point and the No. 2 edge point, the third line for division is a connection line between the No. 2 interior point and the No. 3 edge point, a connection line between the No. 2 interior point and the No. 3 corner point or a connection line between the No. 3 interior point and the No. 2 corner point;
3-2-6) according to a type of the last line for division determined in the previous step, the division mode of the quadrilateral areas and the rule in which the end points are numbered, determining a next line for division as follows:
if the last line for division pertains to the first-type connection line, and the last line and its previous line for division are connected to the same interior point, the next line for division is a connection line between No. (1+1) interior point and No. (2j−1) edge point or a connection line between the No. (i+1) interior point and No. (j+1) corner point; wherein i and j are a sequence number of the first end point and a sequence number of the second end point of the last line for division, respectively;
if the last line for division pertains to the first-type connection line, and the last line for division and its previous line for division are connected to different interior points, the next line for division is a connection line between No. i interior point and No. (2j+1) edge point, a connection line between the No. i interior point and No. (j+2) corner point, a connection line between the No. (i+1) interior point and the No. (2j−1) edge point or a connection line between the No. (i+1) interior point and the No. (j+1) corner point; wherein i and j are the sequence number of the first end point and the sequence number of the second end point of the last line for division, respectively;
if the last line for division pertains to the second-type connection line, and the last line for division and its previous line for division are connected to the same interior point, the next line for division is a connection line between the No. (i+1) interior point and No. (j+1) edge point or a connection line between the No. (i+1) interior point and No. (1+3)/2 corner point; wherein i and j are the sequence number of the first end point and the sequence number of the second end point of the last line for division, respectively;
if the last line for division pertains to the second-type connection line, and the last line for division and its previous line for division are connected to different interior points, the next line for division is a connection line between the No. i interior point and No. (j+2) edge point, a connection line between the No. i interior point and No. (j+5)/2 corner point, a connection line between the No. (i+1) interior point and the No. (j+1) edge point, or a connection line between the No. (i+1) interior point and the No. (j+3)/2 corner point; wherein i and j are the sequence number of the first end point and the sequence number of the second end point of the last line for division, respectively;
if the last line for division is the third-type connection line, the next line for division is a connection line between the No. i interior point and No. (j+1) edge point, a connection line between the No. i interior point and No. (j+4)/2 corner point, or a connection line between the No. (i+1) interior point and the No. (j+2)/2 corner point; wherein i and j are the sequence number of the first end point and the sequence number of the second end point of the last line for division, respectively;
3-2-7) determining whether the sequence number of end points of the next line for division determined in step (3-2-6) is out of limit; wherein if the sequence number of the end points satisfies one of the following conditions, the sequence number of the end points is determined to be out of limit, and the next line for division is deleted:
a) the sequence number of the first end point is greater than 4;
b) the second end point is the corner point, and the sequence number of the second end point is greater than n;
c) the second end point is an odd-numbered edge point, and the sequence number of the second end point is greater than (m−1); and
d) the second end point is an even-numbered edge point, and the sequence number of the second end point is greater than m;
3-2-8) determining the next line for division according to steps (3-2-6)-(3-2-7) until the sequence number of the first end point of the last line is equal to 4, and the sequence number of the second end point of the last line for division satisfies any one of the following conditions:
if the last line for division is the first-type connection line, the sequence number of the second end point of the last line for division is equal to n;
if the last line for division is the second-type connection line, the sequence number of the second end point of the last line satisfies j+1=m; and
if the last line for division is the third-type connection line, the sequence number of the second end point of the last line is equal to m; and
3-2-9) dividing the top surface into a plurality of quadrilateral areas and determining corresponding division mode according to the type of the lines for division determined above.

5. The method of claim 1, wherein the step of optimizing the average quality of the quadrilateral areas using the fruit fly optimization algorithm in step (4) comprises:
4-1) initializing a population size, an iteration number and a flying radius of fruit flies;
4-2) obtaining a linear equation of each edge of the top surface according to coordinates of the corner points on the top surface;
4-3) assigning coordinates of the edge points and the interior points to first-generation fruit fly individuals to allow them to be randomly located on edges and an interior of the top surface, respectively;
4-4) calculating the average qualities of the quadrilateral areas corresponding to the first-generation fruit fly individuals;
4-5) comparing the average qualities of the quadrilateral areas corresponding to the first-generation fruit fly individuals, and reserving the maximum value of the average qualities of the quadrilateral areas and corresponding coordinates of the interior points and edge points;
4-6) assigning coordinates of the interior points and edge points to fruit fly individuals of a next generation to allow the fruit fly individuals of the next generation to be randomly distributed in a circle with the reserved interior points and the reserved edge points as a center and the flying radius as a radius;
4-7) calculating the average qualities of the quadrilateral areas corresponding to the fruit fly individuals in step (4-6);
4-8) comparing the average qualities of the quadrilateral areas corresponding to the fruit fly individuals, and reserving the maximum value of the average qualities of the quadrilateral areas and corresponding coordinates of the interior points and the edge points;
4-9) comparing the maximum value of the average qualities of the quadrilateral areas obtained in step (4-8) with the maximum value of the average qualities of the quadrilateral areas reserved in step (4-5) to obtain and reserve a larger value of the average qualities of the quadrilateral areas and corresponding coordinates of the interior points and the edge points;
4-10) repeating steps (4-6)-(4-9) until the number of running reaches the iteration number of the fruit flies; and
4-11) obtaining a final maximum value of the average qualities of the quadrilateral areas and corresponding coordinates of the interior points and the edge points.

6. The method of claim 5, wherein in step (4-4) or step (4-7), the average qualities of the quadrilateral areas are calculated as follows:
$$q\_average = {\sum }_{i = 0}^{l} {q}_{i} / l , \qquad ( 1 )$$
wherein q_average represents the average quality of the quadrilateral areas in a certain division mode; l represents the number of the quadrilateral areas in the division mode; and qᵢ represents a quality value of an i-th quadrilateral area.

7. The method of claim 6, wherein the average quality of the quadrilateral areas is calculated by steps of:
1) supposing that sequence numbers of vertices of the i-th quadrilateral area are 1, 2, 3, and 4, and vertical coordinates of the vertices of the i-th quadrilateral area are 0, calculating mixed products a, b, and c according to the following expressions:
a=[\vec{23}\vec{24}\vec{(0,0,1)}][\vec{23}\vec{21}\vec{(0,01)}] (2),
b=[\vec{12}\vec{13}\vec{(0,0,1)}][\vec{12}\vec{14}\vec{(0,0,1)}] (3),
c=[\vec{13}\vec{12}\vec{(0,0,1)}][\vec{13}\vec{14}\vec{(0,0,1)}] (4),
wherein each vector is a three-dimensional vector;
2) determining a type of the i-th quadrilateral area according to the mixed products a, b and c:
if a>0, b>0 and c<0, the i-th quadrilateral area is a convex quadrilateral;
if a>0, b<0 and c<0; a>0, b>0 and c>0; a<0, b>0 and c<0; or a<0 and b<0, the i-th quadrilateral area is a concave quadrilateral area; and
if a>0, b<0 and c>0; or a<0, b>0 and c>0, the vertices of the i-th quadrilateral area are crossed;
3) determining the quality value of the i-th quadrilateral area according to the type of the i-th quadrilateral area and the following expressions:
$${q}_{i} = \\ \{ \begin{matrix}{J}_{R} & ( when the i - th quadrilateral area is a convex quadrilateral ) \\ x & ( when the i - th quadrilateral area is a concave quadrilateral ) \\ y & ( when the vertexes of thei - th quadrilateral area are crossed )\end{matrix} , \qquad ( 5 )$$
wherein x and y are self-set penalty coefficients, and y<x<0; J_{R} is a ratio of a minimum value to a maximum value of Jacobian corresponding to each integration point of the i-th quadrilateral area, and a calculation formula of J_{R} is:
$${J}_{R} = \frac{{\vert J \vert}_{min}}{{\vert J \vert}_{max}} , \qquad ( 6 )$$
wherein |J|ₘᵢₙ is the minimum value of the Jacobian corresponding to each integration point of the i-th quadrilateral area; |J|ₘₐₓ is the maximum value of Jacobian corresponding to each integration point of the i-th quadrilateral area; based on the coordinates of each vertex of the i-th quadrilateral area, the Jacobian corresponding to each integration point of the i-th quadrilateral area is calculated as follows:

|J|₁=(x₂−x₁)(y₄−y₁)−(x₄−x₁)(y₂−y₁) (7),

|J|₂=(x₃−x₂)(y₁−y₂)−(x₁−x₂)(y₃−y₂) (8),

|J|₃=(x₄−x₂)(y₂−y₃)−(x₂−x₃)(y₄−y₃) (9),

|J|₄=(x₁−x₄)(y₃−y₄)−(x₃−x₄)(y₁−y₄) (10),
wherein x₁−x₄ are the abscissas of the vertices of the i-th quadrilateral area, and y₁−y₄ are the ordinates of the vertices of the i-th quadrilateral area.

8. The method of claim 1, wherein the step of subjecting the columnar models to structured meshing through a sweep method in step (6) comprises:
6-1) dividing the top surface into a plurality of quadrilateral areas according to the optimal division mode obtained in step (5); and dividing the model of the rotor bar into corresponding number of columnar models with the quadrilateral top surfaces according to the quadrilateral areas;

6. 2) determining an initial size of meshes of the columnar models as follows:
$$V = \sqrt[\frac{3}{2}]{\frac{S}{i}} , \qquad ( 11 )$$
wherein V is the initial size of meshes of the columnar models; S is the area of the top surface; and i is the number of quadrilateral areas on the top surface;
6-3) meshing the columnar models according to the initial size of meshes of the columnar models determined in step (6-2) using the sweep method;
6-4) performing thermal analysis on the finite element models after the meshing to obtain a thermal distribution of the columnar models, and selecting a temperature at any point on the model;
6-5) reducing a size of the meshes to half of the size of the meshes in previous meshing, and meshing the columnar models using the sweep method in step (6-3);
6-6) performing the thermal analysis on the finite element models after the meshing in step (6-5) to obtain the temperature at the same point as in step (6-4);
6-7) comparing the temperature obtained in step (6-6) with the temperature of the same point obtained in the previous thermal analysis to obtain a temperature deviation ΔTᵢ:
ΔTᵢ=|Tᵢ−Tᵢ₋₁₎| (12),
wherein Tᵢ is the temperature of the certain point on the model obtained from this thermal analysis; T₍ᵢ₋₁₎ is the temperature of the same point on the model obtained from the previous thermal analysis;
6-8) determining whether the temperature deviation ΔTᵢ is within a preset threshold range:
ΔTᵢ≤ΔT_{M} (13),
wherein ΔT_{M} is the preset threshold of the temperature deviation ΔTᵢ;
if the temperature deviation is within the preset threshold range, proceeding to the next step; otherwise, returning to step (6-5);
6-9) adopting the obtained meshes as the optimal structured meshing result of the columnar models.
